(19) United States
(12) Patent Application Publication
(10) Pub. No.: US 2010/0117781 A1
(43) Pub. Date: May 13, 2010

(54) Procedure and equipment for the reduction of iron mass requirements of electric machines with prevention of magnetic saturation

(76) Inventor: Pal Tamas Csefko, Budapest (HU)

Correspondence Address: Scott Caridi, 735 Blanch Avenue, Norwood, NJ, 07648, US

(21) Appl. No.: 12/583,356

(22) Filed: Aug. 19, 2009

(30) Foreign Application Priority Data
Nov. 10, 2008 (HU) PO 800658

(51) Int. Cl. H01F 27/24

(52) U.S. Cl. 336/233

(57) ABSTRACT

The invention relates to any procedure and equipment, where laminated, soft magnetic mass is used in a direct and/or indirect form for the production of magnetic fields. For instance applying in inverters, converters, transverters and transformers in such a way, through that we transfer voltage and/or current from the primary side onto the secondary side—with use of a magnetic field. With application of this procedure and interconnected technique, an opportunity presents itself for reduction of both the quantity and the measures of iron mass of laminated transformers to their quarter size, which transformers are applied in electric facilities with operation of low frequency, however independently from the functional frequency and the power of the equipment. The equipment is able to provide much larger starting current and is not sensitive to any spasmodic load either. Thus, it is not necessary to apply expensive semiconductors of high frequency as well as costly technologies.

With application of this new technology and interconnected technique, much lighter equipment can be manufactured with power of just the same size, since the energy density transmitted through the iron mass of this transformer is multiple compared to that if you were to follow the traditional technology.

### FIELD OF APPLICATION

This invention relates to any kind of procedure and equipment, where laminated, soft magnetic material or powered iron ore is used indirectly and/or directly—for the production of a magnetic field. For instance, applying in inverters, converters, transverters and transformers in such a way where we transfer voltage and/or current from the primary side onto the secondary side with the use of a magnetic field. Also applicable in electric motors, where a magnetic field is generated in order to achieve mechanical movement. The application of this new technology allows for the reduction of the iron mass not only at high but also at low frequencies without any power reduction of the electric machines.

### STATUS OF THE PRESENT TECHNOLOGIES

Smaller transformers are being presented in several patents, including one under the name of HIGH FREQUENCY OSCILLATOR-INVERTER known from the Canadian Patents Database—Patent: CA 1232938 Application Number 428909. The patent describes a procedure, where the quantity of iron in the transformer is lower than in other inverters that apply traditional methods. What makes this possible is the quantity of iron in the transformers operated on high frequency can be reduced. These inverters are called switchable high-frequency inverters and have the following functionality: On a transformer operated on high frequency, we produce high-frequency voltage of which we intermit with the necessary frequency. This way, you get low-frequency voltage on output of the inverter. In contrast with the above, the size of transformers applied in traditional low-frequency inverters is very large; therefore their weight is also heavy. To start the energy consumers with an inductive feature, multiple power is necessary, in turn, the starting power of the traditional inverters does not achieve their multiple power, therefore, application of much larger equipment is needed. This way, the issue is how to reduce the mass of the transformer iron substance as well as how to generate multiple starting current compared to the output. On the basis of the procedure as well as with the equipment described in the invention, the mass of the iron substance of transformers and motors applied on low frequency can be reduced to their quarter size compared to the power output.

### SHORT DESCRIPTION OF THE FIGURES

The substance of the patent can be observed in the attached figure that schematically shows the constituent parts of each unit written down in this invention as well as their functional connections.

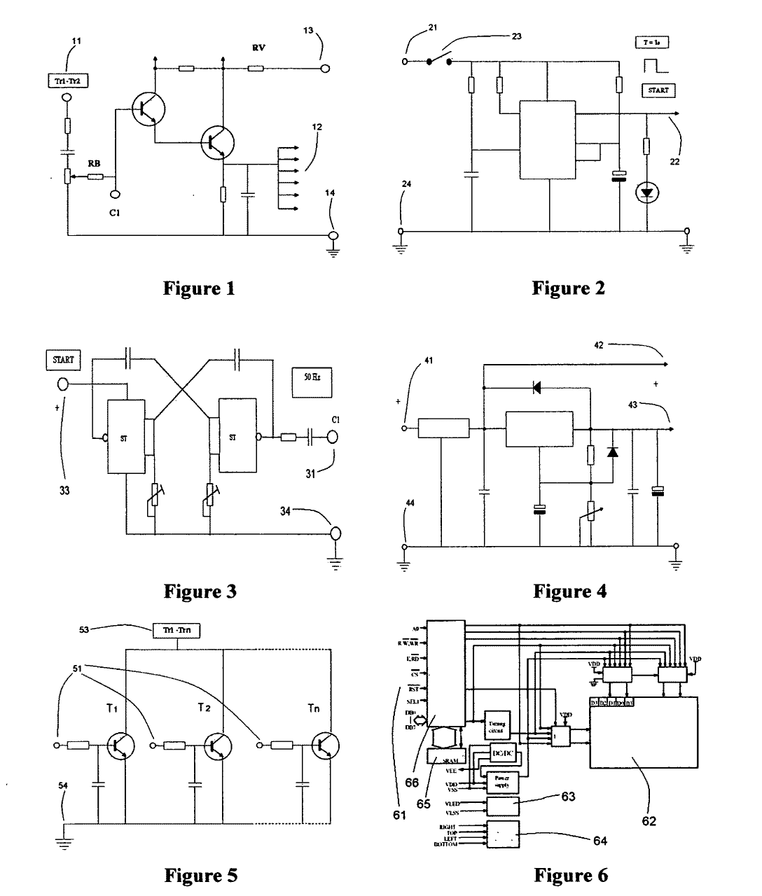

In the FIG. 1 can be seen the Pre-1 and the Pre-2 preamplifier that amplify the feed backed signal for the terminal stage of the power amplifier according to the FIG. 5.

In the FIG. 2 can be seen the timer unit that starts or re-starts the equipment at activation of the system or after automatic cutout at output circuit, with use of the starting oscillator shown on the FIG. 3.

The power supply drawn on FIG. 4 secures the voltage supply of the adjustable preamplifiers being on the FIG. 1.

On the FIG. 6 can be seen the programmed control circuit provided with display unit that ensures the complete adjustable controls through the joining points 61, 62, 63, in an adaptable way as well as the communication through computer towards the external facilities, to the inverter unit.

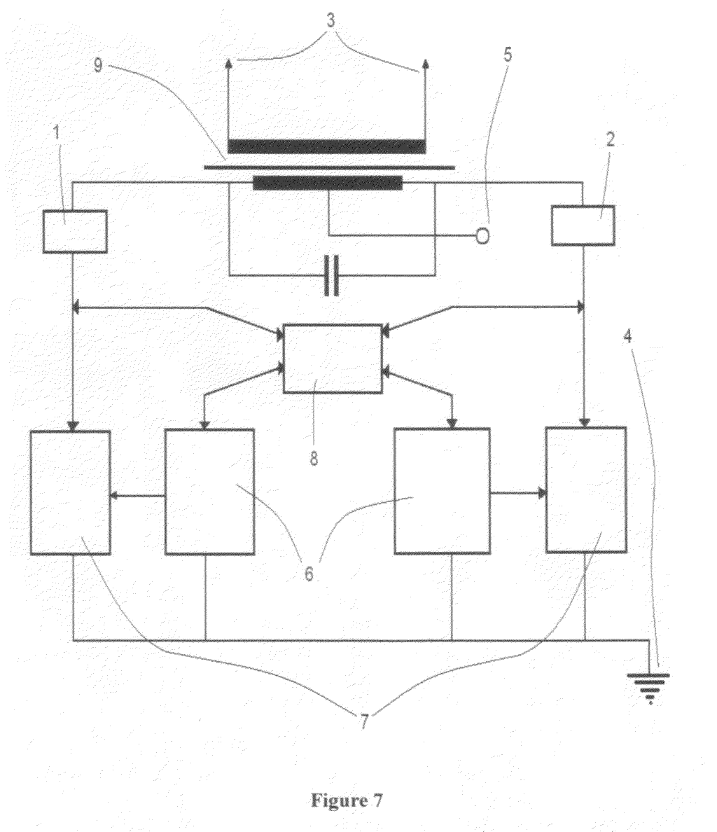

On the FIG. 7, you can see the compilation scheme of each functional unit.

### THE OPERATION OF THE INVENTION

At switching in the 23 main circuit breaker according to the FIG. 2, the timer circuit gives a start impulse through the 22 output onto the 33 input of the oscillator, according to the FIG. 3. The signal generated on the 31 output point of the starting oscillator gives control impulse on the C1 connecting points of the preamplifier unit, according to the FIG. 1 and latches onto the 51 input connecting points of the power amplifier stage through the 12 output points, according to the FIG. 5. The power supply on the FIG. 4 provides the adjustable voltage supply of the preamplifier according to the FIG. 1, independently from the onloading level of the accumulator, through its 43 output point. On the basis of the schematical layout drawn on the FIG. 7, it is noticeable that the circuit inducing the iron uses not direct control, i.e. fixed frequency for the induction of the iron mass but creates a feed backed solution that controls itself.

We can notice this at the Pre-1 and Pre-2 preamplifier units on the FIG. 1 where the inputs of Tr−1 and Tr−2 are connected to the secondary coil-couples fixed on the iron mass. These coil-couples are applied for the induction of the iron mass with use of the Tr−1 and Tr−2 power amplifier stages, according to the FIG. 5, thus, they have a direct connection with each other. They sense hereby instantly how the iron mass runs into saturation, because it is accompanied by significant change in strength of current, however, before it happens, the applied T1, T2, Tn, semiconductors switch over to the other coil-couple and begin the induction of the iron core again. Thus, the iron mass always oscillates on the most appropriate frequency. On the FIG. 6 can be seen the central control unit provided with the 62 display. This is in connection with all of the units, observes the state of the external sensors as well as controls them e.g. in current limit, temperature, voltage level. The equipment is supplied with 61, 63, 64 terminal assignments serving the communication with external facilities.

### ENUMERATION OF FIGURES

FIG. 1 Pre-1, Pre-2 Preamplifier unit
11, Feedback input
12, Connection to terminal stage
13, Way feed voltage (+)
14, Way feed voltage (−)
C1, Connecting point of the control oscillator

FIG. 2 Timer circuit
21, Way feed voltage (+)
22, Start impulse output
23, Switch
24, Way feed voltage (−)

FIG. 3 Starter oscillator
31, Output to preamplifier
33, Start impulse input
34, Way feed voltage (−) FIG. 4 Power supply of preamplifier
41, Way feed voltage (+)
42, Output −1
43, Output −2

FIG. 5 MJ-1, MJ-2, Power amplifier cascade
51, Terminal stage input
53, Terminal Tr1, Tr2,
54, Way feed voltage (−)

FIG. 6 PR-MD-K. Program module supplied with indicator unit
61, Terminals
62, Indicator unit
63, Programmable outputs
64, Programmable input
65, Memory
66, Control

FIG. 7 Compilation scheme
1, 2, Tr−1, Tr2+Fuse
3, AC output
4, Way feed voltage (−)
5, Way feed voltage (+)
6, Pre-1, Pre-2 Preamplifier unit
7, MJ-1, MJ-2, Power amplifier cascade
8, PR-MD-K. Program module supplied with indicator unit
9, Transformer

### COMPENDIUM/SUMMARY

### Procedure and Equipment for the Reduction of Iron Mass Requirements of Electric Machines with Prevention of Magnetic Saturation

The invention relates to any procedure and equipment, where laminated, soft magnetic mass is used in a direct and/or indirect form for the production of magnetic fields. For instance applying in inverters, converters, transverters and transformers in such a way, through that we transfer voltage and/or current from the primary side onto the secondary side—with use of a magnetic field. With application of this procedure and interconnected technique, an opportunity presents itself for reduction of both the quantity and the measures of iron mass of laminated transformers to their quarter size, which transformers are applied in electric facilities with operation of low frequency, however independently from the functional frequency and the power of the equipment. The equipment is able to provide much larger starting current and is not sensitive to any spasmodic load either. Thus, it is not necessary to apply expensive semiconductors of high frequency as well as costly technologies. With application of this new technology and interconnected technique, much lighter equipment can be manufactured with power of just the same size, since the energy density transmitted through the iron mass of this transformer is multiple compared to that if you were to follow the traditional technology.

### PATENT ISSUES

1. Procedure for the reduction of material requirements for iron mass of electric machines, with prevention of magnetic saturation, with the feature that
the requirements for soft magnetic iron mass applied in electric machines can be reduced to their quarter size, independently from the operational frequency of the equipment as well as from its power. Generally, the primary and secondary windings are proportioned to the transmitted power and always oscillate on a frequency necessary to the function. The feed backed signal coming from the driving coils (Tr1, Tr2) with and/or without winding up on the iron mass converts the signal generated into a control signal. The energy density of the iron mass transmitted square inch by square inch is multiple compared to energy density of traditional operation. So, the energy consumption will be reduced because the iron mass to be magnetized is much less compared to the output power of the equipment.

2. Procedure according to the first Patent issue, with the feature that
the (Tr1, Tr2) terminal points of the control and/or field coil of the iron mass applied in the electric machine are adjustable, the initial time and/or the duration and/or the intensity of the current and/or voltage induced with indirect and/or direct coupling can also be set in order to achieve the most optimal function.

3. Procedure according to one of the previous Patent issues, with the feature that
the operation of the equipment that establishes and/or applies the electromagnetic field in an electric machine depends on the functional condition of the electric machine.

4. Procedure according to one of the previous Patent issues, with the feature that
the electronic control system manufactured to the operation of electric machines and the other electronic system for avoiding the saturation of the iron mass of electric machines may be in direct and/or indirect connection with each other.

5. Equipment for reduction of material requirements for iron mass of electric machines, with the prevention of magnetic saturation, with the feature that
the generated signal in the coils fixed on soft magnetic mass is used in a form of control signal with and/or without application of the electronic system so, that it does not let the soft magnetic mass of the coils get into saturation, hereby, the system becomes self-controlling.

6. Equipment according to the 5. Patent issue, with the feature that
the (T1, T2, Tn) switching element can be any electric circuit breaker being in itself well known construction. These can functionally be on the basis of solid and/or of electron-system and/or of ion-system and/or of plasma-system as well. Connection of such kinds of semiconductors can be of Darlington-base. The current flowing through can be controlled in the system and/or by using an external electronic device.

7. Equipment according to one of the 5-6. Patent issues, with the feature that
sensors are there in the iron mass of the electric machine and/or in the coils of it for the sensation of getting of the iron mass into saturation and/or of the current limit.

8. Equipment according to one of the 5-7. Patent issues, with the feature that
the inductive element is an individual inductivity, that has at least 1 primary and 1 secondary coil and the winding of them have partly and/or entirely significant electrical and/or magnetic conductivity. The coil(s) can be connected in series or parallel.

9. Equipment according to one of the 5-8. Patent issues, with the feature that
the drive may be performed through excitation frequency arose on the iron substance of the electric machine and/or through a control released by a programmable component that can be semiconductor, like pic, pik, ram, rom, prom, eprom, eeprom, pal, etc. These semiconductors are well known in application of other technologies.

10. Equipment according to one of the 5-9. Patent issues, with the feature that
the excitation frequency or amplitude arose on the iron substance of the electric machine can under influence of the excitation be temporal and/or final, in case of blending of frequency being constant and/or continuously variable and/or with blending of exterior frequency as well.

1. The aim of this invention is to offer a more economical solution for material requirements for electric machine iron as well as for reduction of their measures. The solution of the invention makes the reduction of the quantity of iron used in the electric machines possible with hindrance of the magnetic saturation. This can be achieved by impeding the saturation of the iron mass of transformers and electric motors, with a specially feed backed electronic control unit, so that the iron mass used in the equipment always oscillates on the most appropriate frequency, which is necessary to its function. The feed backed signal coming from the driving coils with and/or without winding up on the iron mass converts the signal generated through getting the iron mass saturated into a control signal. With the equipment controlled in this manner, the requirement for soft magnetic material will be reduced, achieving much less resistance. Furthermore, with the transformers applied in this manner, a current of much higher value can flow through which will achieve much more economical results. This invention is a procedure according to the patent issues as I describe in 1-4 on page 10 and equipment featured in the patent issues 5-10 on page 10.

2. The iron mass of transformers being installed in this equipment manufactured with this procedure can be reduced compared to the power, however the primary and secondary coils are proportioned to the respective flowing current. The energy density of the transformer used in this way is much larger than at any other applications.

3. The iron material applied in this invention oscillates on a frequency necessary to the most optimal function, therefore its size can be reduced to a great extent. Consequently, much smaller equipment could be produced.

4. The equipment built on the basis of this invention will have MUCH LARGER ENERGY OUTPUT, and possesses multiple starting currents than other equipment operated in a traditional way.

5. The equipment built on the basis of this invention are not sensitive to different spasmodic loads, such as to inductive consumers, since it can take up multiple power as compared with consumers of effective consumption.

6. With the application of this invention, semiconductors of high-frequency and special transformers are not necessary to be used which enlarge the size of the equipment to a great extent.

7. The energy density of the transformer iron mass transmitted square inch by square inch is multiple compared to the position of transformers used in equipment of a traditional operation.
